(19) United States
(12) Patent Application Publication
(10) Pub. No.: US 2025/0139675 A1
(43) Pub. Date: May 1, 2025

(54) METHOD AND SYSTEM FOR CUSTOMER MATCHING WITH SERVICE PROVIDERS

(71) Applicant: Brian R. NASH, Minneola, FL (US)

(72) Inventor: Brian R. NASH, Minneola, FL (US)

(21) Appl. No.: 18/925,209

(22) Filed: Oct. 24, 2024

Related U.S. Application Data
(60) Provisional application No. 63/545,801, filed on Oct. 26, 2023.

(51) Int. Cl. G06Q 30/0283; G06Q 30/08

(52) U.S. Cl. CPC G06Q 30/0283; G06Q 30/08

(57) ABSTRACT

A computer-implemented method of customer matching with service providers includes applying, by the computer system, one or more machine learning models to generate a customer embedding for a customer. The customer embedding is based on a job description for a category of service currently requested by the customer. The method also includes applying one or more machine learning models to generate a service provider embedding for a service provider. The service provider embedding is based on at least one previous job accepted by the service provider through the content provider. The method includes determining an incentive price for the category of service currently requested by the customer based on the customer embedding and the service provider embedding. The method also includes providing the incentive price as a recommendation for the customer to offer through the content provider for an available service provider to perform the service requested by the customer.

### CROSS-REFERENCE TO RELATED APPLICATIONS

This application claims the benefit of U.S. provisional application No. 63/545,801 filed Oct. 26, 2023, which is hereby incorporated herein in its entirety by reference.

### FIELD

The present invention relates to the field of service providers, and, more particularly, to a method and system for customer matching with service providers.

### BACKGROUND

In the past, consumers had to search newspapers, advertisements, and rely on word of mouth to find a service provider for a job. Today, it is easier for consumers to go online to websites that allow consumers to find a service provider for a job. However, a shortcoming to the consumer is not knowing whether they are being overcharged or paying true market value for the services. Also, the service provider does not know the price a customer is willing to pay and may not be compensated fairly for a job, or may not get the job at all if their price is too high. Accordingly, what is needed is transparency in the marketplace.

### SUMMARY

A computer-implemented method of customer matching with service providers is disclosed. The computer-implemented method includes applying, by the computer system, one or more machine learning models to generate a customer embedding for a customer of a content provider. The customer embedding is based on a job description for a category of service currently requested by the customer. The method also includes applying, by a computer system, one or more machine learning models to generate a service provider embedding for a service provider. The service provider embedding is based on at least one previous job accepted by the service provider through the content provider. The method includes determining, by the computer system, a first incentive price for the category of service currently requested by the customer based on the customer embedding and the service provider embedding. The method also includes providing to the customer, by the computer system, the first incentive price as a recommendation for the customer to offer through the content provider for an available service provider to perform the category of service currently requested by the customer.

The computer-implemented method may also include determining, by the computer system, a second incentive price for the category of service currently requested by the customer when the first incentive price is not accepted, and the second incentive price is based on a higher amount over the first incentive price.

The method may also include providing to the customer, by the computer system, the second incentive price as a recommendation for the customer to offer to the available service provider through the content provider to perform the category of service currently requested by the customer. The category of service may include a main category and a sub-category, and the customer embedding may be generated at least in part on text included in the job description of a desired date and a time range for a job start. The customer embedding may also be generated at least in part on text included in the job description of a zip code and a service address.

The service provider embedding may be generated at least in part on text of a price included in the at least one previous job accepted by the service provider, text of a time range for a job start included in the at least one previous job accepted by the service provider, and text of a zip code and a service address included in the at least one previous job accepted by the service provider.

In a particular aspect, a system comprising at least one processor, and a memory storing instructions that, when executed by the at least one processor, cause the system to perform steps as described above. Yet another aspect is directed to a non-transitory computer-readable storage medium including instructions that, when executed by at least one processor of a computing system, cause the computing system to perform steps as described above.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram illustrating a system for customer matching with service providers in accordance with particular aspects of the invention disclosed herein;

FIG. 2 is a flowchart illustrating a method of customer matching with service providers;

FIG. 3 is a continuation of the flowchart illustrating the method of customer matching with service providers of FIG. 2; and

FIG. 4 is a flowchart illustrating a method of generating an incentive price for the method of customer matching with service providers.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one of skill in the art upon reading the following disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

In particular, the present invention is directed to a method and system for consumer matching with service providers. The system and method uses machine learning based on market data and other data to determine a real-time market value for a service.

The real-time market value is based on an arm length transaction between hypothetical consumers and service providers to procure the services at a specific date and time. The real-time market value or “incentive price” is a mechanism for a consumer to submit a competitive price for a desired service at a requested date and time that is most likely to be accepted by a service provider.

For example, the incentive price provides a consumer with the most probable market price that will incentivize a service provider to agree to the date and time of their specific service request. This agreement between the consumer and the service provider establishes a transparent market value of the service delivery between both parties. Without access to the present system and method, the consumer is unable to intelligently offer a competitive market price to incentivize a service provider response at a specific date and time.

In addition, service providers markup the cost to perform a service to a consumer if the request for the service is outside of their normal working hours. The consumer often has no visibility or input to this markup. For example, a plumber may charge a customer at the rate of $100/hour for their services during normal working hours. However, if a consumer needs the plumber to provide an emergency service, outside of their normal working hours, the plumber may charge an increased rate of $150/hour. Today, the increased rate may be unknown to the consumer until the service delivery is agreed upon or completed without any input from the consumer. In summary, the present system and method will create a marketplace and transparency for the cost of procuring services at a specific date and time between both a consumer and a service provider.

In a particular aspect, the present system and method benefits consumers because it will help prevent consumers from being overcharged by service providers for emergency services. The system and method establishes a true market value for the date and time for which a service is provided and agreed upon by both a consumer and a service provider. The system and method provides consumers a mechanism to increase the probability of being able to procure services on the date and time of their choosing.

In another aspect, the present system and method benefits service providers because service providers will know the price a customer is willing to pay for providing a service on the date and time of their request which will create greater customer satisfaction and less payment disputes from a transaction.

In a particular aspect, the method and system converts previous jobs performed by at least one service provider and associated prices into embeddings to determine the incentive price among other things for a current job. While embeddings have been used to match job postings with service providers, the present invention applies a different and specific application of machine learning and reflects an improvement in customers obtaining services from a service provider using the incentive price.

For example, each previous job that was accepted by a service provider through the content provider to perform a particular job description at a price is represented as a high-dimensional vector based on the text description, required skills, qualifications, location, etc. The terms and price negotiations are performed through the content provider so that the content provider stores data that includes the final agreed price for the service. Techniques like Word2Vec, GloVe, or BERT (Bidirectional Encoder Representations from Transformers) can be used to convert the text (including price) into dense embeddings. BERT, for example, would encode the previous jobs in a way that captures the context and relationships between different words and phrases.

Similarly, the profile of a customer is also converted into an embedding. This can include text from the job description of a desired date and a time range for a job start, and text included in the job description of a zip code and a service address, which are transformed using the same or similar embedding models.

Once both the customer and the previous jobs are embedded into vectors, a similarity metric is used to match them. Common similarity measures include cosine similarity (how close the angle between the two vectors is) or Euclidean distance (straight-line distance between the vectors in the embedding space).

The system and method determines whether a current job description requested by a customer and the job description from previous jobs have similar embeddings, and if so then they are considered a good match. For example, if the embedding of a current job is for “repair of a leaking dishwasher” and an embedding for a previous job for “residential plumbing repairs” are close, the system will identify the price for that previous job and adjust the price to account for location, time and date of job start, for example. The adjusted price is provided to the customer as the incentive price to offer to have an increase possibility that a service provider will accept the incentive price to perform the service according to the job description.

In some cases, labeled training data is available, where successful matches (historically hired service providers) and unsuccessful matches are known. A deep learning model, such as a Siamese network, can be trained to learn the best embeddings for matching a job description for a category of service currently requested by the customer to previous jobs accepted by a service provider through the content provider. The model will then adjust the embedding space to place better matches closer together. In the absence of labeled data, unsupervised techniques can be used. Embeddings are generated, and clustering or ranking methods can be applied to find the best matches.

The embeddings are enhanced by adding location, job description similarity, category and sub-category matches, and work experience, for example. These features can either be incorporated into the embedding vectors directly or used as additional inputs in the matching algorithm.

After calculating similarity, the previous jobs are ranked based on how closely their embedding matches the description of service currently requested by the customer embedding. Filters can also be applied to narrow down the list based on hard constraints like location, years of experience, licenses, or certifications.

An example of the system in operation includes to preprocess the description of service currently requested by the customer and previous jobs accepted by a service provider by extracting text from job descriptions. Next, the method includes to embed the description of service currently requested by the customer and to embed the previous jobs accepted by a service provider using pre-trained models (e.g., BERT or specialized job description/price embeddings).

The similarity between the description of service currently requested by the customer and previous jobs may be calculated. For example, the similarity between the embeddings of the description of service currently requested by the customer and previous jobs accepted by a service provider may be calculated using cosine similarity or another metric.

The previous jobs that were accepted are ranked by how well they match the description of the service currently requested by the customer. The previous jobs may also be filtered based on additional features, and those filtered jobs are used in determining the incentive price.

Embeddings capture deep semantic relationships in the current job descriptions and previous jobs descriptions, going beyond keyword matching. In addition, embeddings reduce dimensionality, making it computationally feasible to compare millions of previous jobs with the description of the service currently requested by the customer and to determine the incentive price.

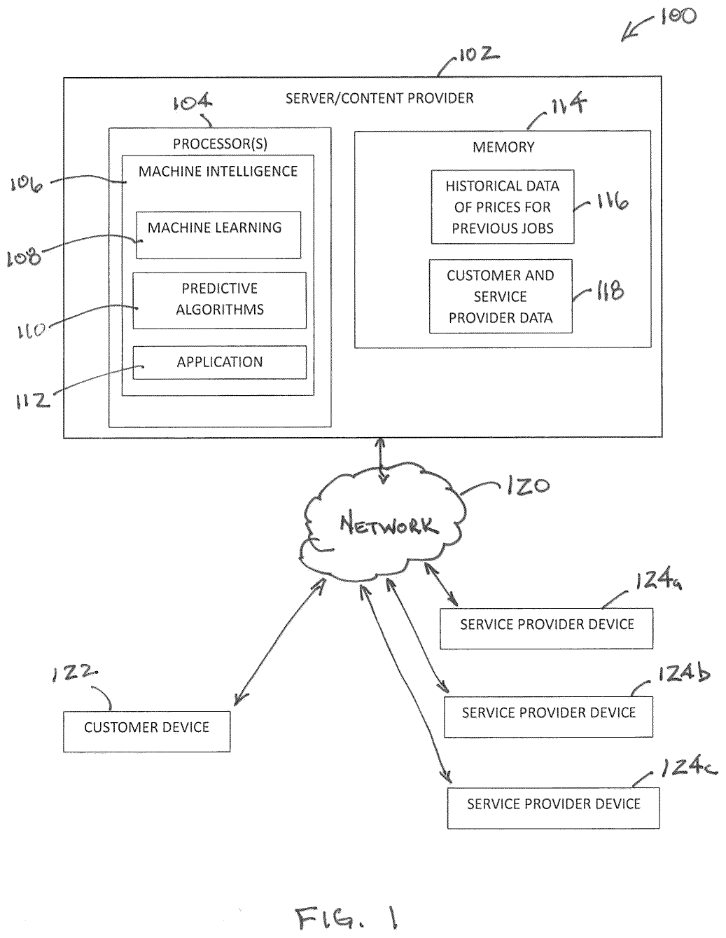

Turning to FIG. 1, a block diagram of the system for consumer matching with service providers 100 is depicted in accordance with an illustrative embodiment. The system 100 comprises a server 102, at least one consumer devices 122, and service provider devices 124a, 124b, 124c. The server 102 comprises processors 104, and machine intelligence 106. Machine intelligence 106 includes machine learning 108, predictive algorithms 110, and an application 112.

Machine intelligence 106 can be implemented using one or more systems, such as an artificial intelligence system, a neural network, a Bayesian network, an expert system, a fuzzy logic system, a genetic algorithm, or other suitable types of systems. Machine learning 108 and predictive algorithms 110, in addition to other elements and programs, such as application 112, make the server 102 a special purpose computer for a system for consumer matching with service providers.

Predictive algorithms 110 may be configured for use by machine intelligence 106 to use patterns and anomalies, as well as numerical values, statistical weights for determining an incentive price that is likely to be accepted by a service provider for a particular job and associated requirements for the job. The machine or artificial intelligence of the system is also configured to automate emails and push notification messages to the service providers and customers over the network 120.

The memory 114 comprises a plurality historical data of prices for previous jobs 116, and customer and service provider data 118.

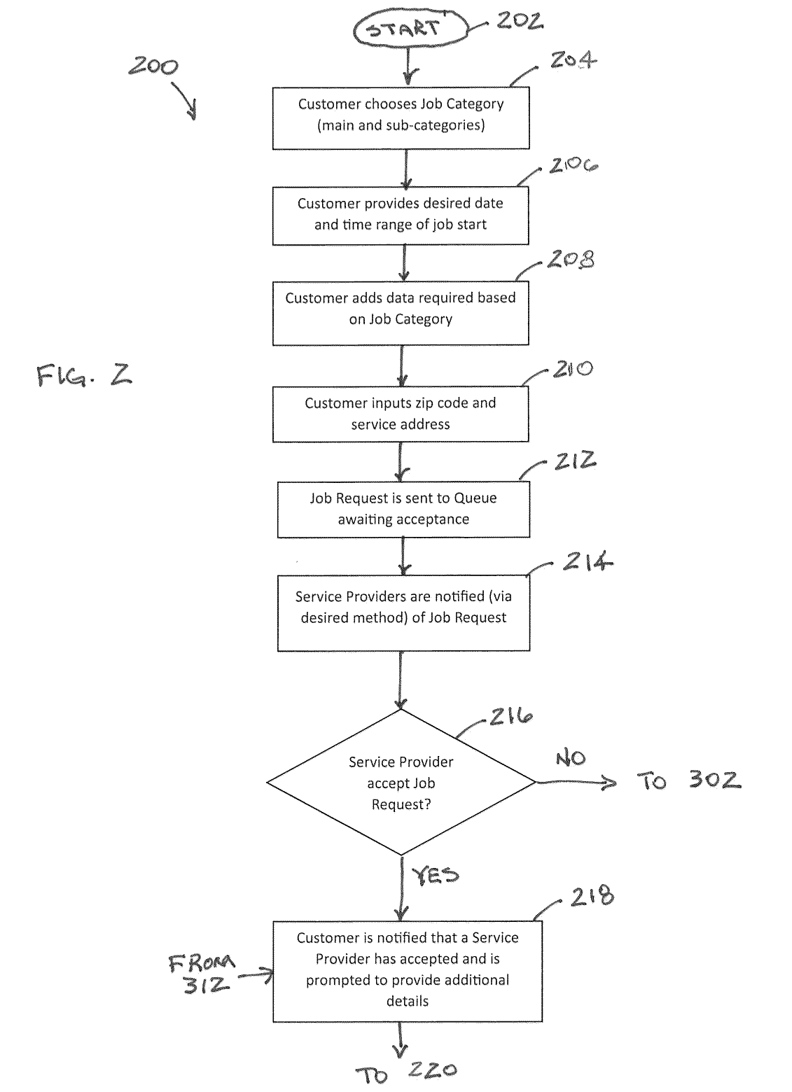

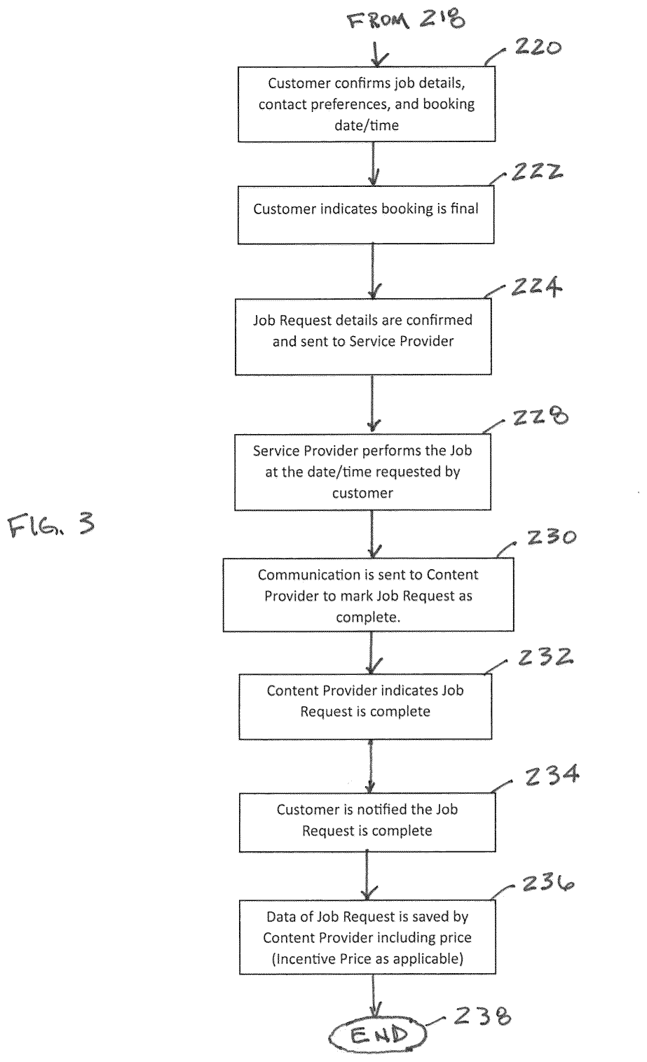

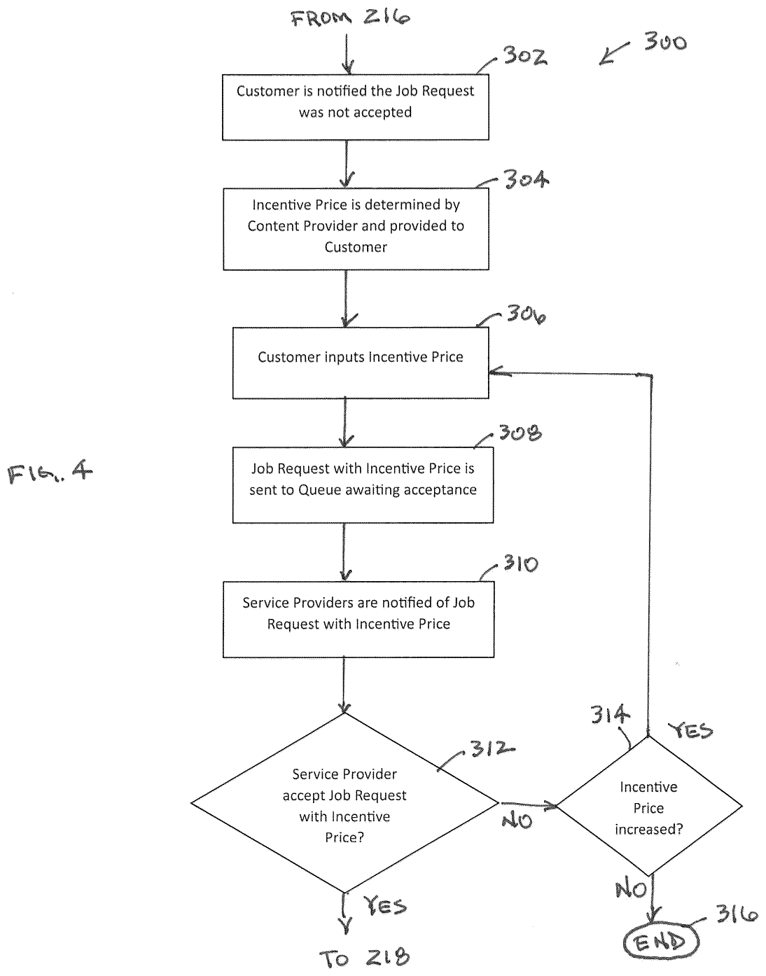

Referring now to FIGS. 2-4, a general flow chart of the method is depicted and generally designated 200. The method begins, at 202, with the customer choosing a job category comprising a main category and a sub-category, at 204. Next, the customer provides, at 206, a desired date/time range of job start. The customer adds data required based on job category using screen prompts of the graphical user interface (GUI), at 208. Moving to 210, the customer inputs zip code and service address, if applicable. If the customer does not have an account, then the customer can create an account and the method continues at 212, where a job request is sent to a queue awaiting acceptance. The service providers are notified (via desired method) that a job request is available, at 214.

If the service provider accepts the job request, at 216, then the customer is notified that a service provider has accepted and is prompted by the GUI to provide additional details, at 218.

If the service provider does not accept the job request, at 216, then the customer is notified, at 302, that the service provider has not accepted the job request and the customer is prompted to provide an additional monetary incentive. An incentive price is generated by the content provider, at 304, using artificial intelligence and machine learning described above based on historical data, service category and season, for example.

Machine intelligence includes machine learning, and predictive algorithms and can be implemented using one or more systems, such as an artificial intelligence system, a neural network, a Bayesian network, an expert system, a fuzzy logic system, a genetic algorithm, or other suitable types of systems. Predictive algorithms may be configured for use by machine intelligence to use patterns and anomalies, as well as numerical values, statistical weights for determining the incentive price most likely to be accepted by a service provider.

Once the incentive price is generated, at 304, the customer submits the incentive price or the customer can manually enter a desired amount of money, at 306. The job request with the incentive price is then sent to the queue awaiting acceptance, at 308. The service providers are notified (via desired method) of the job request having an incentive price, at 310. If a service provider accepts the job request with the incentive price, at 312, then the customer is notified, at 218, that a service provider has accepted and is prompted to provide additional details.

If no service provider accepts the job request, at 312, with the incentive price, then at 314, the customer is notified and prompted to increase the incentive price. The method repeats again with a new incentive price, at 306, until a service provider accepts the job request, or the customer terminates the job request, at 316.

Once the customer is notified that a service provider has accepted, the customer is prompted by the GUI to provide additional details, at 218. The customer confirms, at 220, the lead data details, contact preferences, and booking date/time. The customer indicates booking is final, at 222, subject to cancellation fees, and the job request details are confirmed and sent to service provider, at 224. The service provider may also be charged a booking fee once the job request details are confirmed.

If booking is cancelled, the customer begins again, at 212, with the job request being sent to the queue awaiting acceptance. Otherwise, the method continues, to 228, where the service provider performs the job at the date/time requested by the customer. A communication is sent to the content provider, at 230, to mark the job as complete. Moving to 232, the content provider indicates the job is complete and the customer is notified the job is complete, at 234, and may be prompted to take additional actions. The data of the job request is saved by the content provider, at 236, including price, and may be used in the future to calculate an incentive price for a similar job request for another customer. The method 200 ends at 238.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

1. A computer-implemented method of customer matching with service providers, the computer-implemented method comprising:
applying, by the computer system, one or more machine learning models to generate a customer embedding for a customer of a content provider, the customer embedding based on a job description for a category of service currently requested by the customer;
applying, by a computer system, one or more machine learning models to generate a service provider embedding for a service provider, the service provider embedding based on at least one previous job accepted by the service provider through the content provider;
determining, by the computer system, a first incentive price for the category of service currently requested by the customer based on the customer embedding and the service provider embedding; and
providing to the customer, by the computer system, the first incentive price as a recommendation for the customer to offer through the content provider for an available service provider to perform the category of service currently requested by the customer.

2. The computer-implemented method of claim 1, further comprising determining, by the computer system, a second incentive price for the category of service currently requested by the customer when the first incentive price is not accepted, and the second incentive price is based on a higher amount over the first incentive price.

3. The computer-implemented method of claim 2, further comprising providing to the customer, by the computer system, the second incentive price as a recommendation for the customer to offer to the available service provider through the content provider to perform the category of service currently requested by the customer.

4. The computer-implemented method of claim 1, wherein the category of service comprises a main category and a sub-category.

5. The computer-implemented method of claim 1, wherein the customer embedding is generated at least in part on text included in the job description of a desired date and a time range for a job start.

6. The computer-implemented method of claim 1, wherein the customer embedding is generated at least in part on text included in the job description of a zip code and a service address.

7. The computer-implemented method of claim 1, wherein the service provider embedding is generated at least in part on text of a price included in the at least one previous job accepted by the service provider.

8. The computer-implemented method of claim 1, wherein the service provider embedding is generated at least in part on text of a time range for a job start included in the at least one previous job accepted by the service provider.

9. The computer-implemented method of claim 1, wherein the service provider embedding is generated at least in part on text of a zip code and a service address included in the at least one previous job accepted by the service provider.

10. A system comprising:
at least one processor; and
a memory storing instructions that, when executed by the at least one processor, cause the system to perform:
applying one or more machine learning models to generate a customer embedding for a customer of a content provider, the customer embedding based on a job description for a category of service currently requested by the customer,
applying one or more machine learning models to generate a service provider embedding for a service provider, the service provider embedding based on at least one previous job accepted by the service provider through the content provider,
determining a first incentive price for the category of service currently requested by the customer based on the customer embedding and the service provider embedding, and
providing to the customer the first incentive price as a recommendation for the customer to offer through the content provider for an available service provider to perform the category of service currently requested by the customer.

11. The system of claim 10, further comprising determining, by the computer system, a second incentive price for the category of service currently requested by the customer when the first incentive price is not accepted, and the second incentive price is based on a higher amount over the first incentive price.

12. The system of claim 11, further comprising providing to the customer, by the computer system, the second incentive price as a recommendation for the customer to offer to the available service provider through the content provider to perform the category of service currently requested by the customer.

13. The system of claim 10, wherein the category of service comprises a main category and a sub-category.

14. The system of claim 10, wherein the customer embedding is generated at least in part on text included in the job description of a desired date and a time range for a job start.

15. The system of claim 10, wherein the customer embedding is generated at least in part on text included in the job description of a zip code and a service address.

16. The system of claim 10, wherein the service provider embedding is generated at least in part on text of a price included in the at least one previous job accepted by the service provider.

17. The system of claim 10, wherein the service provider embedding is generated at least in part on text of a time range for a job start included in the at least one previous job accepted by the service provider.

18. A non-transitory computer-readable storage medium including instructions that, when executed by at least one processor of a computing system, cause the computing system to perform a method comprising:
applying one or more machine learning models to generate a customer embedding for a customer of a content provider, the customer embedding based on a job description for a category of service currently requested by the customer,
applying one or more machine learning models to generate a service provider embedding for a service provider, the service provider embedding based on at least one previous job accepted by the service provider through the content provider,
determining a first incentive price for the category of service currently requested by the customer based on the customer embedding and the service provider embedding, and
providing to the customer the first incentive price as a recommendation for the customer to offer through the content provider for an available service provider to perform the category of service currently requested by the customer.

19. The non-transitory computer-readable storage medium of claim 18, further comprising instructions for determining, by the computer system, a second incentive price for the category of service currently requested by the customer when the first incentive price is not accepted, and the second incentive price is based on a higher amount over the first incentive price.

20. The non-transitory computer-readable storage medium of claim 19, further comprising instructions for providing to the customer, by the computer system, the second incentive price as a recommendation for the customer to offer to the available service provider through the content provider to perform the category of service currently requested by the customer.
